(19) United States
(12) Patent Application Publication
(10) Pub. No.: US 2006/0007802 A1
(43) Pub. Date: Jan. 12, 2006

(54) Optical disk reproducing device

(75) Inventor: Tsutomu Inada, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-shi (JP)

(21) Appl. No.: 11/173,830

(22) Filed: Jul. 1, 2005

(30) Foreign Application Priority Data
Jul. 6, 2004 (JP) 2004-199553

(51) Int. Cl. G11B 7/00

(52) U.S. Cl. 369/44.27; 369/44.23

(57) ABSTRACT

An optical disk reproducing device accurately measuring a defect signal and having increased accuracy of an automatic adjustment includes an objective lens and light receiving element unit reading a signal from an optical disk, a CPU for making a determination, according to whether values of three signals fall out of a prescribed range, as to whether the three signals are defect signals or not, a tracking control unit for generating a signal representing an estimated position of the objective lens when the signals are defect signals, and generating a signal representing the same content as that of the signals read by the objective lens and light receiving element unit when the signals are not defect signals, and an actuator for changing a position of the objective lens according to a content of the signal generated by the tracking control unit.

### BACKGROUND OF THE INVENTION

1. Field of the Invention

The present invention relates to an optical disk reproducing device and, more specifically, to an optical disk reproducing device reading a value from light reflected from an optical disk.

2. Description of the Background Art

In an optical disk reproducing device which reads a value from light reflected from an optical disk, an accurate value cannot be measured in measurement of a level of a tracking error signal when there is a scratch on a disk. Various solutions to this problem have been proposed.

Japanese Patent Laying-Open No. 61-145736 discloses a tracking jump preventing device which controls an open-loop gain of a tracking servo corresponding to a result of comparisons of a difference between a tracking error signal itself and a tracking error signal subjected to a slew rate limitation and an envelope signal obtained from an output of an optical pickup with respective reference values. With this preventing device, a track jump can be prevented without fault even when there is a scratch on a deposition surface besides a transparent base material of a disk.

Japanese Patent Laying-Open No. 63-224035 discloses a reproducing device in which a level of a driving signal to an actuator is suppressed only when an optical disk is in an abnormal condition such that an irradiation position of light to the optical disk is moved onto a track from which information has been already read. With this reproducing device, movement of the irradiation position in a direction opposite to a direction of reading information can be prevented.

Japanese Patent Laying-Open No. 09-139037 discloses a track jump preventing circuit which decreases a tracking gain when a scratch signal is output, which scratch signal is a logical sum of a signal of detection of a scratch on a surface of a transparent layer of an optical disk and a signal of detection of a scratch formed on a deposition surface. With this circuit, a track jump can be prevented without fault because not only a scratch on the surface of the transparent layer of the optical disk but also a scratch on the deposition surface are detected.

Japanese Patent Laying-Open No. 11-003558 discloses a scratch detecting device which generates a signal corresponding to a result of a comparison between a sum of absolute values of signals each having a phase varying complimentarily in accordance with deviation from a track of an optical disk and a reference value. With this device, an accurate detection of a scratch is enabled with a simple construction and with clear differentiation from tracking error detection.

In controlling of an open-loop gain of a tracking servo as disclosed in Japanese Patent Laying-Open No. 61-145736, however, consideration is not given to quality of a resulting signal. When data such as numbers or characters is to be read, required data can be obtained easily even if there is a problem in quality of a resulting signal to a degree (even if a resulting value lacks accuracy). On the other hand, when a signal representing a picture or a sound is to be read, the picture or sound is largely affected by quality of a resulting signal. This means that, it is difficult to obtain a picture or a sound of good quality with the device disclosed in Japanese Patent Laying-Open No. 61-145736. Each of the devices and the like disclosed in Japanese Patent Laying-Open Nos. 63-224035, 9-139037 and 11-003558 also has a similar problem.

### SUMMARY OF THE INVENTION

The present invention is made to solve the above-described problem. An object of the present invention is to provide an optical disk reproducing device which accurately measures a defect signal and has increased accuracy of an automatic adjustment to obtain a picture or a sound of good quality.

To attain the aforementioned object, an optical disk reproducing device according to one aspect of the present invention includes an objective lens and light receiving element unit for reading a signal representing a position from an optical disk, a determination circuit for making a determination, according to whether values of at least three signals read by the objective lens and light receiving element unit fall out of a prescribed range or not, as to whether the three signals read by the objective lens and light receiving element unit are defect signals representing existence of a defect or not, a tracking control unit for generating a signal representing an estimated position of the objective lens using a signal read by the objective lens and light receiving element unit immediately before reading of the defect signals when the determination circuit determines that the signals read by the objective lens and light receiving element unit are defect signals, and generating a signal representing the same content as that of a signal read by the objective lens and light receiving element unit when the determination circuit determines that values of the signals are signals other than defect signals, and an actuator for changing a position of the objective lens to the optical disk according to a content of the signal generated by the tracking control unit.

That is, when it is determined that the signals representing positions which are read by the objective lens and light receiving element unit are defect signals, the tracking control unit generates, in place of the defect signals, a signal representing an estimated position of the objective lens using a signal read by the objective lens and light receiving element unit immediately before reading of the defect signals, and when it is determined that values of the signals are signals other than defect signals, the tracking control unit generates a signal representing the same content as that of a signal read by the objective lens and light receiving element unit. With this, a signal representing an appropriate position can be output as a signal representing a position of the objective lens and light receiving element unit. As a result, an optical disk reproducing device is provided which accurately measures a defect signal and has increased accuracy of an automatic adjustment to obtain a picture or a sound of good quality.

An optical disk reproducing device according to another aspect of the present invention includes a reader for reading a signal representing a position from an optical disk, a determination circuit for making a determination as to whether the signal read by the reader is a defect signal representing existence of a defect or not, a tracking control unit for generating a signal representing a position of the reader when the determination circuit determines that the signal read by the reader is the defect signal, and generating a signal representing the same content as that of the signal read by the reader when the determination circuit determines that a value of the signal is a signal other than the defect signal, and an actuator for changing a position of the reader to the optical disk according to a content of the signal generated by the tracking control unit.

With this, a signal representing an appropriate position can be output as a signal representing a position of the reader. As a result, an optical disk reproducing device is provided which accurately measures a defect signal and has increased accuracy of an automatic adjustment to obtain a picture or a sound of good quality.

In addition, the tracking control unit preferably includes a control unit for generating a signal representing an estimated position of the reader using a read signal which is read by the reader before reading of the defect signal.

That is, a signal representing a position of the reader becomes more accurate.

In addition, the read signal is preferably a signal read by the reader immediately before reading of the defect signal.

Furthermore, the determination circuit preferably includes a circuit for making a determination, according to whether values of a plurality of signals read by the reader fall out of a prescribed range or not, as to whether all of the plurality of signals are defect signals or not.

Furthermore, a number of the plurality of signals is preferably at least three.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a control block diagram of an optical record reproducing device according to an embodiment of the present invention.

FIG. 2 shows a construction of an RF amplifier unit according to the embodiment of the present invention.

FIG. 3 is a flow chart of a controlling procedure of tracking control processing according to the embodiment of the present invention.

FIG. 4 shows relations of a tracking error signal, an RF signal and a scratch detection signal according to the embodiment of the present invention.

### DESCRIPTION OF THE PREFERRED EMBODIMENTS

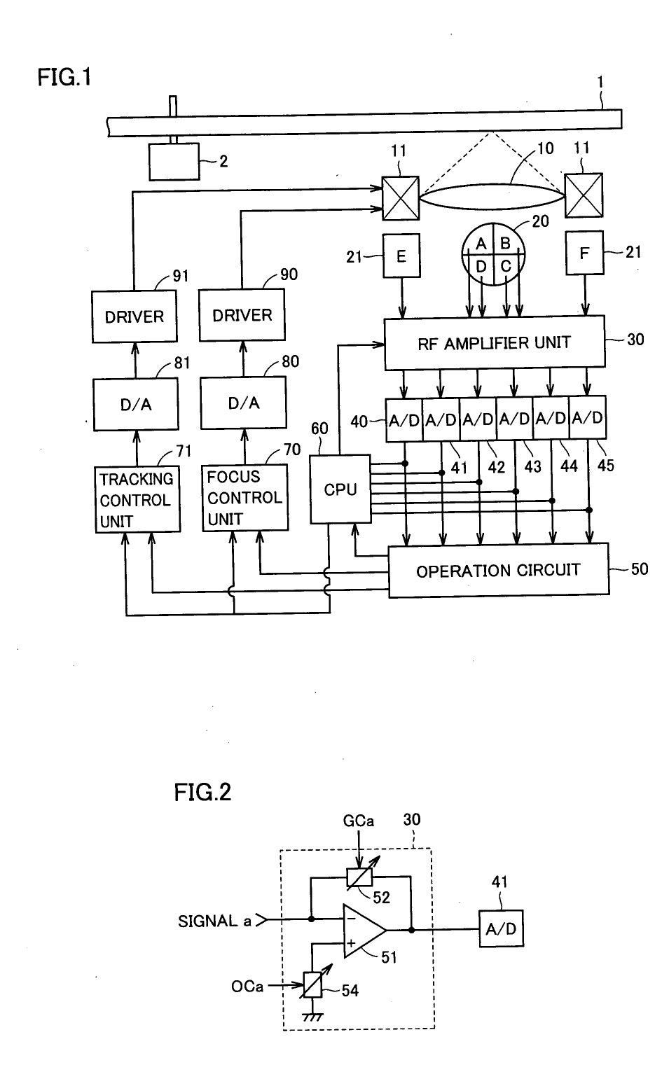

FIG. 1 shows a construction of a main portion of an optical record reproducing device according to an embodiment of the present invention. The optical record reproducing device according to this embodiment is a device for recording data onto a DVD (Digital Versatile Disk) and reproducing recorded data. Referring to FIG. 1, the optical record reproducing device includes an optical pickup device including a spindle motor 2 for rotating an optical disk 1, an objective lens 10 for collecting a beam emitted from a light source which is not shown on optical disk 1, and an actuator 11 for controlling and driving objective lens 10 in a focus direction and a tracking direction, a light receiving element unit for receiving a beam reflected from a recording surface of optical disk 1, an RF amplifier unit 30, a first A/D (Analog-to-Digital) converter 40, a second A/D converter 41, a third A/D converter 42, a fourth A/D converter 43, a fifth A/D converter 44, and a sixth A/D converter 45.

The light receiving element unit is formed with a photodetector 20 which is split in four in a cross shape and a photodetector 21 which is split in two. Objective lens 10 and photodetector 20 form a device for reading a signal representing a position (in this embodiment, presence or absence of a tracking error) from optical disk 1.

Photodetector 20 is split in two in a radial direction of optical disk 1 and split in two in a tangential direction to form four regions A-D. When a light beam reflected from optical disk 1 is collected and enters, four regions A, B, C, and D respectively output an electric signal a, an electric signal b, an electric signal c, and an electric signal d corresponding to an amount of reflected light input.

Photodetector 21 is split in two in a radial direction of optical disk 1 to form a region E and a region F. When a light beam reflected from optical disk 1 is collected and enters, two regions E and F respectively output an electric signal e and an electric signal f corresponding to an amount of reflected light input.

RF amplifier unit 30 is formed with a plurality of differential amplifiers having respective electric signals a-f as input voltages. Differential amplification for each of electric signals a-f is performed in RF amplifier unit 30, and the result is output.

First to sixth A/D converters 40-45 are arranged in parallel corresponding to output signals of RF amplifier unit 30. First to sixth A/D converters 40-45 convert electric signals a-f input via RF amplifier unit 30 into digital signals and output the results.

The optical record reproducing device further includes an operation circuit 50 for performing operation processing of output signals for electric signals a-f, that is, electric signals a-f converted into digital forms to generate a focus error signal and a tracking error signal, a CPU (Central Processing Unit) 60, a focus control unit 70, a tracking control unit 71, a first D/A (Digital-to-Analog) converter 80, a second D/A converter 81, a first driver 90, and a second driver 91.

Operation circuit 50 includes three adder circuits and a differential circuit (not shown). Two of the adder circuits respectively calculate a sum signal (a+c) of electric signals from region A and region C and a sum signal (b+d) of electric signals from region B and region D, which respective two regions of four regions of photodetector 20 are diagonal to each other. The sum signal (a+c) and sum signal (b+d) of electric signals resulting from adding operations are output to a remaining adder circuit and the differential circuit. The adder circuit obtains a total value (a+c)+(b+d) of the sum signal (a+c) and sum signal (b+d) and provides the result as an RF signal to CPU 60. The differential circuit obtains a differential (a+c)−(b+d) between the sum signal (a+c) and sum signal (b+d) and provides the result as a focus error signal to focus control unit 70.

Operation circuit 50 further includes a differential circuit which is not shown. The differential circuit obtains a differential (e−f) between electric signal e and electric signal f from regions E and F of photodetector 21 and provides the result as an tracking error signal to tracking control unit 71.

As described above, in this embodiment, an error signal is generated based on a three-beam method. Techniques such as a push-pull method and an astigmatism method are known as other techniques to generate an error signal. The present invention can be applied to these techniques. It is to be noted that, in the astigmatism method, a tracking error signal can be obtained with a signal (a+c)−(b+d) obtained by the operation of electric signals a-d of photodetector 20 split in four, similarly as for the focus error signal.

Focus control unit 70 and tracking control unit 71 generate a focus drive signal and a tracking drive signal based on error signals obtained.

Generated focus drive signal and tracking drive signal are respectively converted into analog signals with first D/A converter 80 and second D/A converter 81 and input to first driver 90 and second driver 91.

First driver 90 drives actuator 11 in a focus direction based on the focus drive signal so as to bring a light spot into a focus. Second driver 91 drives actuator 11 in a tracking direction based on the tracking drive signal so as to place the light spot on a center of a track of the optical disk.

As described above, in this embodiment, a dynamic range of the A/D converter can be made narrower with a construction in which the electric signal detected with the photodetector is directly input to the A/D converter. When an output amplitude of the electric signal is beyond the dynamic range, however, a waveform saturation of the electric signal occurs and accuracy of a servo control is degraded.

Therefore, with adjustments of an offset and a gain for the electric signal, the waveform saturation of the electric signal which may occur in the A/D converter having a narrow dynamic range can be avoided to enable a stable servo control. In this embodiment, RF amplifier unit 30 further includes an offset adjustment function and a gain adjustment function to implement a stable servo control.

FIG. 2 shows a construction of RF amplifier unit 30 shown in FIG. 1. RF amplifier unit 30 includes a plurality of differential amplifiers arranged for respective electric signals a-f. Since each of the differential amplifiers has the same construction, a differential amplifier 51 arranged corresponding to electric signal a is representatively shown in FIG. 2.

Referring to FIG. 2, differential amplifier 51 is an inverting amplifier, and electric signal a is input to an inverting input terminal. An output terminal of differential amplifier 51 is coupled to an input terminal of second A/D converter 41. A variable resistor 52 is coupled as a feedback resistance between the inverting input terminal and the output terminal. A variable resistor 54 is coupled between a non-inverting input terminal and a ground potential.

An output voltage of differential amplifier 51 can be offset by adjusting a resistance value of variable resistor 54 connected to the non-inverting input terminal of differential amplifier 51. Therefore, variable resistor 54 functions as an offset adjustment unit.

Furthermore, a gain of differential amplifier 51 can be increased or decreased by adjusting a resistance value of variable resistor 52. Therefore, variable resistor 52 functions as a gain adjustment unit.

The variable resistor as the offset adjustment unit and the variable resistor as the gain adjustment unit are similarly arranged for each of the differential amplifiers which are not shown.

The resistance value of variable resistor 54 is adjusted corresponding to a control signal from CPU 60 shown in FIG. 1.

Referring back to FIG. 1, CPU 60 receives output signals of first to sixth A/D converters 40-45 to measure a direct current (DC) level of each output signal. An obtained DC level is compared with a reference voltage (corresponding to a median of the dynamic range of the A/D converter) to calculate a differential therebetween. CPU 60 sends a control signal to variable resistor 54 of RF amplifier unit 30 or the like so as to make the differential “zero”, that is, to match the DC level of the output signal with the reference voltage.

Variable resistor 54 adjusts the resistance value according to a corresponding control signal. With this, an output voltage of differential amplifier 51 (that is, each of input signals of first to sixth A/D converters 40-45) is offset and the DC level is set to the median of the dynamic range.

The resistance value of variable resistor 52 is adjusted corresponding to a control signal from CPU 60. CPU 60 receives output signals of first to sixth A/D converters 40-45 to measure a potential difference (output amplitude) between maximum and minimum values of each output signal. CPU 60 further makes a determination as to whether an obtained potential difference falls within the dynamic range of the A/D converter or not. When the potential difference does not fall within the dynamic range, CPU 60 sends a control signal to variable resistor 52 of RF amplifier unit 30 or the like so as to make the potential difference fall within the dynamic range.

Variable resistor 52 or the like adjusts the resistance value according to a corresponding control signal. With this, a gain of differential amplifier 51 or the like is adjusted and an output voltage (that is, each of input signals of first to sixth A/D converters 40-45) is adjusted so as to make the output amplitude fall within the dynamic range.

CPU 60 is also a circuit to detect existence of a scratch on optical disk 1 using an output of operation circuit 50. When the existence of a scratch is detected, CPU 60 outputs a signal representing the existence to focus control unit 70 and tracking control unit 71. An algorithm for detecting the scratch will be described below in detail.

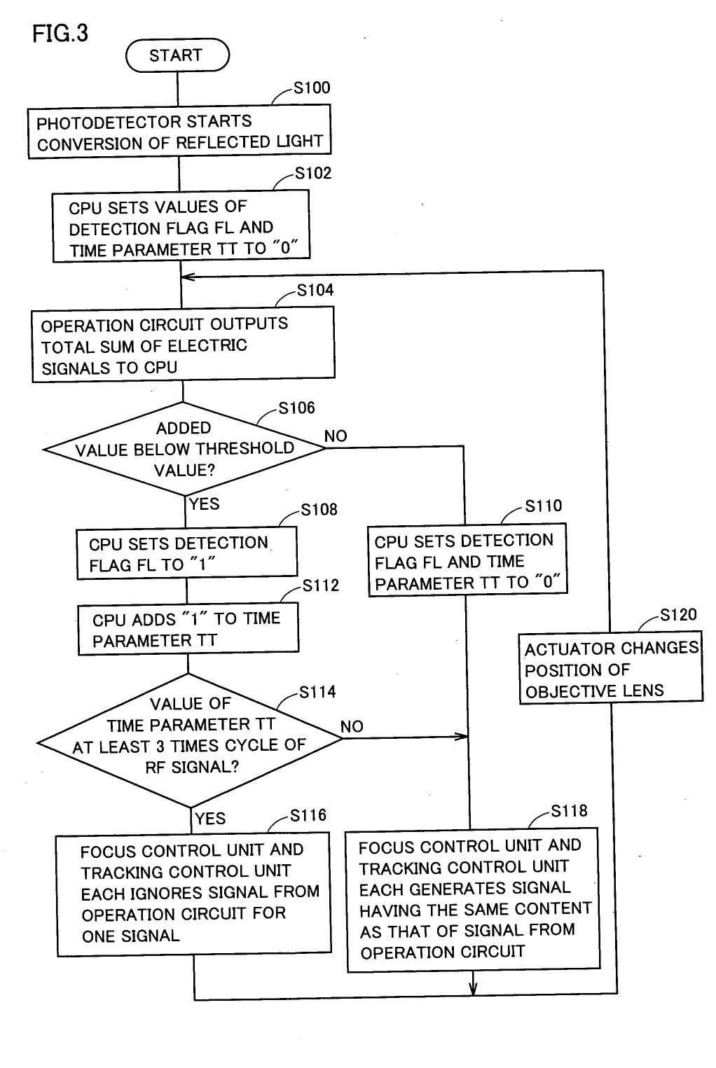

Referring to FIG. 3, a program executed in the optical record reproducing device has a control structure as described below regarding a tracking control.

In step 100 (hereafter, “step” is abbreviated as “S”), photodetector 20 and photodetector 21 start reading and conversion of light reflected from optical disk 1. RF amplifier unit 30 amplifies signals converted by photodetector 20 and photodetector 21. First to sixth A/D converters 40-45 convert the signals converted by RF amplifier unit 30 into digital signals. First to sixth A/D converters 40-45 output the digital signals to operation circuit 50.

In S102, CPU 60 sets a detection flag FL and a time parameter TT to “ ”. In S104, operation circuit 50 outputs to CPU 60 a total sum of the digital signals output from first to sixth A/D converters 40-45.

In S106, CPU 60 makes a determination as to whether or not a value output from operation circuit 50 is below a threshold value (this value can be determined arbitrarily by a designer of the optical record reproducing device according to this embodiment). When it is determined that the value is below the threshold value (YES in S106), processing is moved to S108. Otherwise (NO in S106), the processing is moved to S110. In S108, CPU 60 sets detection flag FL to “1”. In S110, CPU 60 sets detection flag FL and time parameter TT to “0”. In S112, CPU 60 adds “1” to time parameter TT.

In S114, CPU 60 makes a determination as to whether or not a value of time parameter TT is at least three times a cycle of the RF signal. When it is determined that the value is at least three times the cycle of the RF signal (YES in S114), the processing is moved to S116. Otherwise (NO in S114), the processing is moved to S118.

In S116, each of focus control unit 70 and tracking control unit 71 ignores the signal output from CPU 60 for one signal. In place of the signal output from CPU 60, each of focus control unit 70 and tracking control unit 71 assumes that a signal which is read by photodetector 20 immediately before reading of a defect signal (a signal representing a position of photodetector 20) is input again, and generates a signal representing the same content as that of the signal. Focus control unit 70 and tracking control unit 71 output generated signals to first D/A converter 80 and second D/A converter 81, respectively.

In S118, each of focus control unit 70 and tracking control unit 71 generates a signal having the same content as that of a signal output from operation circuit 50 (a signal representing a position of photodetector 20). Focus control unit 70 and tracking control unit 71 output generated signals to first D/A converter 80 and second D/A converter 81, respectively.

In S120, first D/A converter 80 and second D/A converter 81 change a position of objective lens 10 to optical disk 1 corresponding to contents of the signals generated by focus control unit 70 and tracking control unit 71.

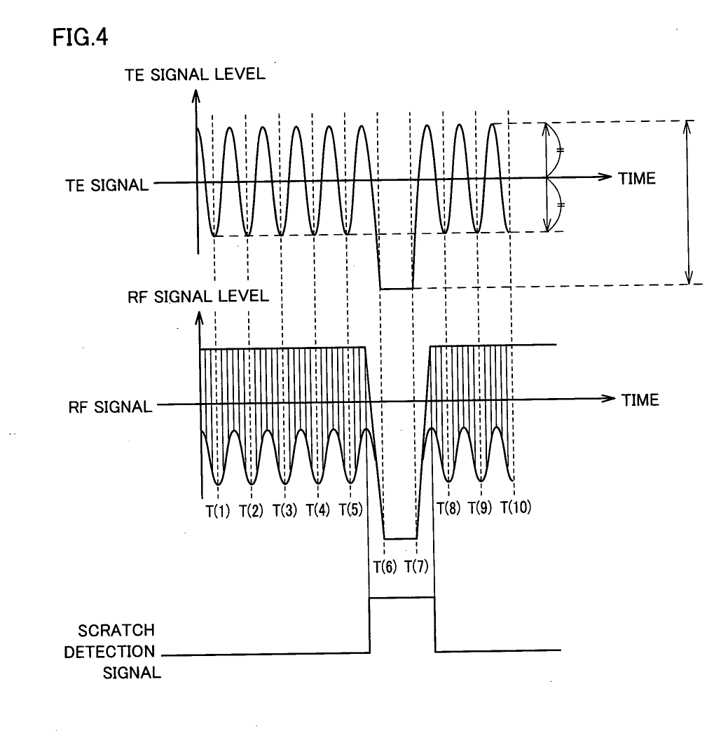

Referring to FIG. 4, an operation of the optical record reproducing device based on the structure and flow chart as described above will be described. FIG. 4 shows relations of the tracking error signal, the RF signal and a scratch detection signal according to the embodiment of the present invention.

Concurrently with starting of optical disk reproduction, photodetector 20 and photodetector 21 start conversion of light reflected from optical disk 1 (S100). When the conversion of reflected light is started, CPU 60 sets detection flag FL and time parameter TT to “0” (S102). When the flag and parameter are set, operation circuit 50 outputs to CPU 60 a total sum of the digital signals output from first to sixth A/D converters 40-45 (S104). When the total sum is output, CPU 60 makes a determination as to whether or not the value output from operation circuit 50 is below the threshold value (S106). Initially, the value output from operation circuit 50 is not below the threshold value (NO in S106), and therefore CPU 60 sets detection flag FL and time parameter TT to “0” (S110). When the flag and parameter are set, each of focus control unit 70 and tracking control unit 71 generates the signal having the same content as that of the signal output from operation circuit 50. Focus control unit 70 and tracking control unit 71 output generated signals to first D/A converter 80 and second D/A converter 81, respectively (S118). When the signals are output, first D/A converter 80 and second D/A converter 81 change a position of objective lens 10 to optical disk 1 corresponding to contents of the signals generated by focus control unit 70 and tracking control unit 71 (S120). Thereafter, the processing of S104-S120 is repeated until a time T(5).

At time T(5), CPU 60 again makes a determination as to whether or not the value output from operation circuit 50 is below the threshold value (S106). After time T(5), the output value substantially decreases. Therefore, the value output from operation circuit 50 becomes lower than the threshold value (YES in S106), and thus CPU 60 sets detection flag FL to “1” (S108). CPU 60 adds “1” to time parameter TT (S112). When a value of the flag is set, CPU 60 makes a determination as to whether or not a value of time parameter TT is at least three times the cycle of the RF signal (S114). With the processing of S106-S114, based on whether values of a plurality (at least three in this embodiment) of signals read by photodetector 20 fall out of a prescribed range or not, CPU 60 makes a determination as to whether or not all of the plurality of signals read by photodetector 20 are defect signals representing existence of a defect (in this embodiment, a defect regarding detection of a tracking error). Since it is not initially determined that the value is at least three times the cycle of the RF signal (NO in S114), the processing of S118-S112 is repeated. According to FIG. 4, however, the value output from operation circuit 50 is below the threshold value until a time T(8). As a result of the value output from operation circuit 50 being below the threshold value, it is finally determined that the value of time parameter TT is at least three times the cycle of the RF signal (YES in S114), and therefore each of focus control unit 70 and tracking control unit 71 ignores the signal output from CPU 60 for one signal (S116). After the signal being ignored for one signal, the processing of S1120-S114 is again repeated. With the processing of S116-S118, when CPU 60 determines that the signals read by photodetector 20 are defect signals, tracking control unit 71 generates a signal representing a position of photodetector 20, and when CPU 60 determines that values of the signals read by photodetector 20 are signals other than defect signals, tracking control unit 71 generates a signal representing the same content as that of a signal read by photodetector 20.

As described above, when a level of the tracking error signal is measured, the optical record reproducing device according to this embodiment makes a determination as to whether there is a scratch on an optical disk or not from a waveform of a signal read from the optical disk. When there is no scratch on the optical disk, an obtained signal is regarded as a normal signal and the processing is continued. When there is a scratch on the optical disk, a tracking control is performed similarly as in a situation in which a scratch is absent. When there is a scratch on the optical disk, a signal obtained with detecting the scratch is a false signal. When the false signal is reproduced as a sound or a picture, a dropout in the sound or a disturbance in the picture occurs. In the optical record reproducing device according to this embodiment, when a signal of a place of a scratch is detected, the signal will not be processed. When a signal of a place of a scratch is detected, the optical record reproducing device according to this embodiment keeps a previous level of a control. Since the control as such is performed, the tracking error signal is accurately measured and accuracy of an automatic adjustment can be increased. Therefore, a picture or a sound of good quality can be obtained by reproducing picture or sound data with the optical record reproducing device according to this embodiment. As a result, an optical record reproducing device can be provided which accurately measures the defect signal and has increased accuracy of the automatic adjustment to obtain a picture or a sound of good quality.

It is to be noted that, in S106, CPU 60 may make a determination as to whether or not a rate of change of a value output from operation circuit 50 is larger than a certain value, in place of the determination as to whether the value is below the threshold value or not. In this situation, the determination as to whether or not the rate of change of the value output from operation circuit 50 is larger than the certain value is made based on whether a value resulting from removal of a high frequency component of the value output from operation circuit 50 beforehand with a low-pass filter is larger than the certain value or not.

In addition, in S114, CPU 60 may make a determination as to whether or not a value of time parameter TT is at least 14 times the cycle of the RF signal. Presence or absence of a scratch on the optical disk can be detected if the value of time parameter TT is less than 14 times the cycle of the RF signal provided that the value is sufficiently larger than the cycle of the RF signal. When the value of time parameter TT is at least 14 times the cycle of the RF signal, however, presence or absence of a scratch on the optical disk can be detected with higher accuracy.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An optical disk reproducing device, comprising:
an objective lens and light receiving element unit for reading a signal representing a position from an optical disk;
a determination circuit for making a determination, according to whether values of at least three signals read by said objective lens and light receiving element unit fall out of a prescribed range or not, as to whether the three signals read by said objective lens and light receiving element unit are defect signals representing existence of a defect or not;
a tracking control unit for generating a signal representing an estimated position of said objective lens using a signal read by said objective lens and light receiving element unit immediately before reading of said defect signals when said determination circuit determines that the signals read by said objective lens and light receiving element unit are defect signals, and generating a signal representing the same content as that of a signal read by said objective lens and light receiving element unit when said determination circuit determines that values of said signals are signals other than defect signals; and
an actuator for changing a position of said objective lens to said optical disk according to a content of the signal generated by said tracking control unit.

2. An optical disk reproducing device, comprising:
a reader for reading a signal representing a position from an optical disk;
a determination circuit for making a determination as to whether the signal read by said reader is a defect signal representing existence of a defect or not;
a tracking control unit for generating a signal representing a position of said reader when said determination circuit determines that the signal read by said reader is the defect signal, and generating a signal representing the same content as that of the signal read by said reader when said determination circuit determines that a value of said signal is a signal other than the defect signal; and
an actuator for changing a position of said reader to said optical disk according to a content of the signal generated by said tracking control unit.

3. The optical disk reproducing device according to claim 2, wherein
said tracking control unit includes a control unit for generating a signal representing an estimated position of said reader using a read signal read by said reader before reading of the defect signal.

4. The optical disk reproducing device according to claim 3, wherein
said read signal is a signal read by said reader immediately before reading of the defect signal.

5. The optical disk reproducing device according to claim 2, wherein
said determination circuit includes a circuit for making a determination, according to whether values of a plurality of signals read by said reader fall out of a prescribed range or not, as to whether all of said plurality of signals are defect signals or not.

6. The optical disk reproducing device according to claim 5, wherein
a number of said plurality of signals is at least three.
